(19) United States
(12) Patent Application Publication
(10) Pub. No.: US 2017/0222244 A1
(43) Pub. Date: Aug. 3, 2017

(54) SOLID ELECTROLYTE AND LITHIUM BATTERY COMPRISING THE SOLID ELECTROLYTE

(71) Applicants: Samsung Electronics Co., Ltd., Suwon-si (KR); Seoul National University R&DB Foundation, Seoul (KR)

(72) Inventors: Hyunjin Kim, Suwon-si (KR); Joonhee Kim, Seoul (KR); Victor Roev, Suwon-si (KR); Hyukjae Kwon, Suwon-si (KR); Dongmin Im, Seoul (KR); Kisuk Kang, Gwacheon-si (KR); Youngjoon Bae, Seoul (KR)

(21) Appl. No.: 15/402,435

(22) Filed: Jan. 10, 2017

(30) Foreign Application Priority Data
Feb. 3, 2016 (KR) 10-2016-0013538

(51) Int. Cl. H01M 8/1039; H01M 8/1048; H01M 10/0565; H01M 12/08; H01M 10/0525

(52) U.S. Cl. CPC H01M 8/1039; H01M 12/08; H01M 10/0525; H01M 10/0565; H01M 8/1048; H01M 2008/1095

(57) ABSTRACT

A solid electrolyte includes: an ionic liquid; a lithium salt; an inorganic particle; and a polymer, wherein an amount of the ionic liquid is greater than or equal to about 33 parts by weight, based on 100 parts by weight of the polymer. Also a lithium battery including the solid electrolyte and a method of preparing a composite electrolyte membrane including the solid electrolyte.

### CROSS-REFERENCE TO RELATED APPLICATION

This application claims priority to and the benefit of Korean Patent Application No. 10-2016-0013538, filed on Feb. 3, 2016, in the Korean Intellectual Property Office, and all the benefits accruing therefrom under 35 U.S.C. §119, the content of which is incorporated herein in its entirety by reference.

### BACKGROUND

1. Field

The present disclosure relates to a solid electrolyte and a lithium battery including the solid electrolyte.

2. Description of the Related Art

A lithium-air battery includes a negative electrode that allows deposition and dissolution of lithium ions, a positive electrode for oxidizing and reducing oxygen from the air, and a lithium-ion conducting medium between the positive electrode and the negative electrode.

The lithium-air battery may use lithium as the positive electrode and may have a high capacity because there is no need to store air in the battery as a positive active material. The lithium-air battery may thus have a high theoretical specific energy of about 3500 watt-hours per kilogram (Wh/kg) or greater, which is approximately ten times greater than that of a lithium ion battery.

A lithium-air battery may use either a liquid electrolyte or solid electrolyte.

A liquid electrolyte may have high ionic conductivity, but may increase a total weight of a battery when a large amount of liquid electrolyte is used to fill the pores of the positive electrode, thus making it difficult to manufacture a lithium-air battery having high specific energy. Furthermore, the liquid electrolyte may be more likely to leak.

Materials for use as solid electrolytes may include a solid electrolyte including a ceramic and a solid electrolyte including a polymer. Solid electrolytes including a ceramic are strong but heavy, and are likely to crack due to a lack of flexibility. On the other hand, solid electrolytes including a polymer are flexible but are more likely to deteriorate and may not be effective at ensuring good cycle characteristics of a lithium-air battery.

Therefore, there is a need for a solid electrolyte that is flexible and may also provide improved cycle characteristics.

### SUMMARY

Provided is a solid electrolyte.

Provided also is a lithium battery including the solid electrolyte.

According to an aspect of an embodiment, a solid electrolyte includes: an ionic liquid; a lithium salt; an inorganic particle; and a polymer, wherein an amount of the ionic liquid is greater than or equal to about 33 parts by weight, based on 100 parts by weight of the polymer.

According to an aspect of another embodiment, a lithium battery includes: a positive electrode; a negative electrode; and an electrolyte layer disposed between the positive electrode and the negative electrode, wherein the electrolyte layer includes a solid electrolyte including an ionic liquid, a lithium salt, an inorganic particle, and a polymer, wherein an amount of the ionic liquid is greater than or equal to about 33 parts by weight, based on 100 parts by weight of the polymer.

According to an aspect, a method of preparing a composite electrolyte membrane includes: providing a separator; and impregnating the separator with a solid electrolyte to prepare the composite electrolyte membrane, wherein the solid electrolyte includes an ionic liquid, a lithium salt, an inorganic particle, and a polymer, wherein an amount of the ionic liquid is greater than or equal to about 33 parts by weight, based on 100 parts by weight of the polymer.

According to another aspect, a method of preparing a lithium battery includes: providing a positive electrode; providing a negative electrode; and disposing an electrolyte layer between the positive electrode and the negative electrode to prepare the lithium battery, the electrolyte layer including an ionic liquid, a lithium salt, an inorganic particle, and a polymer, wherein an amount of the ionic liquid is greater than or equal to about 33 parts by weight, based on 100 parts by weight of the polymer,

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a graph of ionic conductivity (Siemens per centimeter, S/cm) versus reciprocal temperature (1000/T, Kelvin⁻¹ (K⁻¹)) for the solid electrolyte membranes of Example 2 and Comparative Example 4;

FIG. 2 is a graph of specific energy (watt-hour per kilogram, Wh/kg) versus cycle number illustrating the lifetime characteristics of the lithium-air batteries of Example 5, Example 6, and Comparative Example 6;

FIG. 3 is a graph of specific energy (Wh/kg) versus cycle number illustrating the lifetime characteristics of the lithium-air batteries of Example 6, Example 8, and Comparative Example 6;

FIG. 4 is a graph of capacity (ampere-hours per gram, Ah/g) versus cycle number illustrating the lifetime characteristics of the lithium-air batteries of Example 7 and Comparative Example 7;

FIG. 5 is a schematic view illustrating a structure of a lithium-air battery according to an embodiment;

FIG. 6 is a schematic view illustrating a structure of a lithium-air battery according to another embodiment; and

FIG. 7 is a schematic view illustrating a structure of a lithium ion battery according to another embodiment.

### DETAILED DESCRIPTION

Reference will now be made in detail to embodiments of a solid electrolyte and a lithium battery including any of the solid electrolytes, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “liquid” refers to a flowable material having a non-freestanding shape at room temperature, e.g., a flowable state where the shape is determined by a shape of a container holding the flowable material, and as such, the shape varies depending upon a shape of a container of the liquid.

The term “liquid electrolyte” refers to a flowable electrolyte which does not have a freestanding shape at room temperature and for which a shape is determined by a shape of a container holding the liquid electrolyte.

As used herein, the term “solid” refers to a non-flowable material having a freestanding shape at room temperature.

The term “solid electrolyte” refers to a material having lithium ionic conductivity that maintains a freestanding shape at room temperature, e.g., a non-flowable electrolyte. The term “solid electrolyte” refers to an electrolyte including not including a solvent, wherein the solvent is a non-ionically conductive low-molecular weight material which is a liquid at room temperature (e.g., water or an organic solvent). A “solid electrolyte” includes an electrolyte which has been prepared using a solvent, and the solvent has been substantially removed by, for example, drying.

The term “ionic liquid” refers to an ionically conductive low-molecular material which is liquid at room temperature, and thus is not considered to be a solvent within the context of this disclosure.

According to an aspect of the present disclosure, there is provided a solid electrolyte including an ionic liquid, a lithium salt, an inorganic particle, and a polymer, wherein the amount of the ionic liquid is greater than or equal to about 33 parts by weight, based on 100 parts by weight of the polymer. For example, the amount of the ionic liquid may be from about 33 parts by weight to about 300 parts by weight, and in some embodiments, 40 parts by weight to about 200 parts by weight, and in some other embodiments, about 50 parts by weight to about 150 parts by weight, and in some other embodiments, about 80 parts by weight to about 120 parts by weight, based on 100 parts by weight of the polymer. When the amount of the ionic liquid in the solid electrolyte is too small (e.g., lower than 33 parts by weight), the solid electrolyte may have deteriorated mechanical properties, and thus may not form a self-standing film and may have reduced ionic conductivity. When the amount of the ionic liquid is too large (e.g., greater than about 200 parts by weight), a liquid electrolyte rather than the solid electrolyte, may be formed.

The solid electrolyte including an ionic liquid, a lithium salt, an inorganic particle, and a polymer and having with the above-described ratio of the ionic liquid to the polymer, and may have improved flexibility and improved charge and discharge characteristics. For example, the solid electrolyte may be a free-standing film without a support, and for example, may be in the form of a foldable, flexible self-standing film. For example, the flexible self-standing film may be a paper-like film, e.g., a film having a thickness of about 0.01 millimeter (mm) to about 1 mm, or about 0.05 mm to about 0.5 mm. For example, the solid electrolyte may be mechanically robust. The solid electrolyte may be capable of being shaped into any of a variety of shapes due to its flexibility, and thus may accommodate a change in either volume or shape which may occur during charging and discharging of a lithium battery. For example, the solid electrolyte may be durable against charging and discharging processes. The strength and durability of the solid electrolyte can be attained by inclusion of a polymer with a higher degree of durability.

For example, the polymer of the solid electrolyte may be an alkylene oxide-free (e.g., non-alkylene oxide-containing) polymer. That is, the polymer of the solid electrolyte may be distinct from a polyethylene oxide polymer and does not contain alkylene oxide structural units. While not wanting to be bound by theory, it is understood that a polymer including alkylene oxide repeating units, such as polyethylene oxide (PEO), may be prone to deteriorate during charging and discharging processes. For example, the polymer of the solid electrolyte may be a non-ionic polymer, and is not be an ionic liquid polymer. Thus, for example, the polymer of the solid electrolyte may be any suitable polymer, except for an alkylene oxide-including polymer, and further comprises a polymeric ionic liquid (e.g., an ionic polymer).

For example, the polymer of the solid electrolyte may be at least one selected from polyethylene, polypropylene, polytetrafluoroethylene (PTFE), polyvinylidene fluoride (PVdF), styrene-butadiene rubber, a tetrafluoroethylene-perfluoroalkyl vinyl ether copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoroethylene copolymer, an ethylene-acrylic acid copolymer, polyacrylonitrile, and polymethyl methacrylate. However, embodiments are not limited thereto. The polymer of the solid electrolyte may be any polymer suitable for use as a solid electrolyte, except for polymers including an alkylene oxide group and ionic liquid polymers.

For example, the solid electrolyte may be a polymer fiber-free electrolyte, e.g., an electrolyte which does not include polymer fibers. For example, the solid electrolyte may not include a polymer fiber having a diameter of about 10 nanometers (nm) to about 100 micrometers (μm). A scanning electron microscope (SEM) may be used to determine whether the solid electrolyte includes a polymer fiber. Since the solid electrolyte does not include such a polymer fiber, the polymer in the solid electrolyte may be homogeneously distributed throughout the solid electrolyte.

For example, the ionic liquid of the solid electrolyte may be represented by Formula 1 or 2.

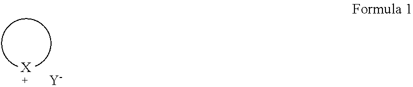

In Formula 1,

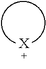

is a 3 to 31-membered ring including 2 to 30 carbon atoms and at least one heteroatom, and may be a cycloalkyl ring, an aryl ring, or a heteroaryl ring;

X may be —N(R₁)(R₂), or —P(R₁)(R₂); R₁ and R₂ are each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group; and Y⁻ may be an anion.

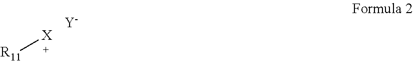

In Formula 2, X may be —N(R₁)(R₂)(R₃), or —P(R₁)(R₂)(R₃); R₁ to R₃ may be each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group; R₁₁ may be an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group; and Y⁻ may be an anion.

For example, in the ionic liquid of the solid electrolyte, of Formula 1 may be represented by a compound of Formula 3, and

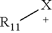

in Formula 2 may be a cation represented by Formula 4.

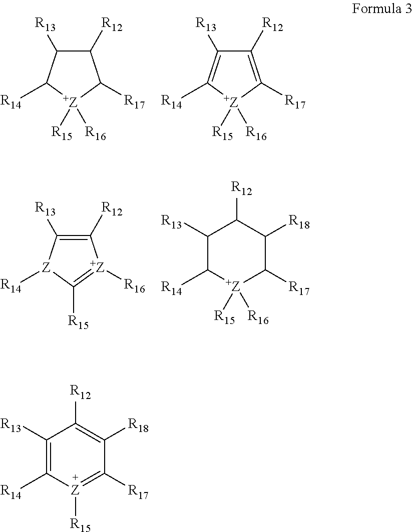

In Formula 3, Z may be nitrogen (N) or phosphorus (P); and R₁₂ to R₁₈ may be each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group.

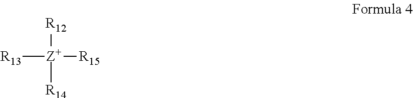

In Formula 4, Z may be nitrogen (N) or phosphorus (P); and R₁₂ to R₁₅ may be each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group.

For example, the ionic liquid may include at least one selected from [emim]Cl/AlCl₃, [bmpyr]NTf₂, [bpy]Br/AlCl₃ (wherein bpy=4,4′-bipyridine), [choline]Cl/CrCl₃.6H₂O, [Hpy(CH₂)₃pyH][NTf₂]₂, [emim]OTf/[hmim]I, [choline]Cl/HOCH₂CH₂OH, [Et₂MeN(CH₂CH₂OMe)]BF₄, [Bu₃PCH₂CH₂C₈F₁₇]OTf, [bmim]PF₆, [bmim]BF₄, [omim]PF₆, [Oct₃PC₁₈H₃₇]I, [NC(CH₂)₃mim]NTf₂, [Pr₄N][B(CN)₄], [bmim]NTf₂, [bmim]Cl, [bmim][Me(OCH₂CH₂)₂OSO₃], [PhCH₂mim]OTf, [Me₃NCH(Me)CH(OH)Ph]NTf₂, [pmim][(HO)₂PO₂], [b(6-Me)quin]NTf₂, [bmim][Cu₂Cl₃], [C₁₈H₃₇OCH₂mim]BF₄, [heim]PF₆, [mim(CH₂CH₂O)₂CH₂CH₂mim][NTf₂]₂, [obim]PF₆, [oquin]NTf₂, [hmim][PF₃(C₂F₅)₃], [C₁₄H₂₉mim]Br, [Me₂N(C₁₂H₂₅)₂]NO₃, [emim]BF₄, [mm(3-NO₂)im][dinitrotriazolate], [MeN(CH₂CH₂OH)₃], [MeOSO₃], [Hex₃PC₁₄H₂₉]NTf₂, [emim][EtOSO₃], [choline][ibuprofenate], [emim]NTf₂, [emim][(EtO)₂PO₂], [emim]Cl/CrCl₂, and [Hex₃PC₁₄H₂₉]N(CN)₂, wherein im is imidazolium, emim is ethyl methyl imidazolium, mm is dimethyl, bppyr is butyl methyl pyridinium, NTf is trifluoromethanesulfonimide, bpy is 4,4′-bipyridine, hmim is hexyl methyl imidazolium, Et is ethyl, Me is methyl, Pr is propyl, Bu is butyl, Ph is phenyl, Oct is octyl, Hex is hexyl, OTf is trifluoromethane sulfonate, bmim is butyl methyl imidazolium, omim is octyl methyl imidazolium, mim is methyl imidazolium, pmim is propyl methyl imidazolium, obim is octyl butyl imidazolium, bquin is butyl quinolinium, heim is hexyl ethyl imidazolium, and oquin is octyl quinolinium. However, embodiments are not limited thereto. Any suitable material, including those available as an ionic liquid in the art, may be used.

For example, the ionic liquid may include at least one selected from N,N-diethyl-N-methyl-N-(2-methoxyethyl)ammonium tetraborate ([DEME][BF₄]), diethylmethylammonium trifluoromethanesulfonate ([dema][TfO]), dimethylpropylammonium trifluoromethanesulfonate ([dmpa][TfO]), diethylmethylammonium trifluoromethanesulfonyl imide ([DEME][TFSI]), and methylpropylpiperidinium trifluoromethanesulfonyl imide ([mpp][TFSI]). However, embodiments are not limited thereto. Any ionic liquid suitable for use as a solid electrolyte, including those available in the art, may be used.

For example, the ionic liquid of the solid electrolyte may have a molecular weight of less than 1000 Daltons (Da). For example, the ionic liquid of the solid electrolyte may have a molecular weight of less than or equal to about 900 Da, and in some embodiments, less than or equal to about 800 Da, and in some other embodiments, less than or equal to about 700 Da, and in some other embodiments, less than or equal to about 600 Da, and in some other embodiments, less than or equal to about 500 Da. When the molecular weight of the ionic liquid is within any of the above ranges, a lithium battery with improved cycle characteristics may be obtained.

For example, the amount of the polymer in the solid electrolyte may be from about 30 parts by weight to about 300 parts by weight based on 100 parts by weight of the ionic liquid. For example, the amount of the polymer in the solid electrolyte may be from about 40 parts by weight to about 200 parts by weight, and in some embodiments, from about 50 parts by weight to about 150 parts by weight, and in some embodiments, from about 70 parts by weight to about 130 parts by weight, and in some other embodiments, from about 80 parts by weight to about 120 parts by weight, based on 100 parts by weight of the ionic liquid. When the amount of the polymer in the solid electrolyte is too small (e.g., less than 80 parts by weight based on 100 parts by weight of the ionic liquid), the polymer may fail to form a solid electrolyte at room temperature, and instead, a liquid electrolyte may be obtained. When the amount of the polymer in the solid electrolyte is too large (e.g., greater than 300 parts by weight based on 100 parts by weight of the ionic liquid), the solid electrolyte may have reduced ionic conductivity.

For example, the lithium salt of the solid electrolyte may include at least one selected from lithium bis(trifluoromethane)sulfonimide (LiTFSI), LiPF₆, LiBF₄, LiAsF₆, LiClO₄, LiNO₃, lithium bis(oxalato) borate (LiBOB), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and lithium trifluoromethanesulfonate (LiTfO). However, embodiments are not limited thereto. Any lithium salt suitable for use as a solid electrolyte may be used.

For example, the amount of the lithium salt in the solid electrolyte may be from about 33 parts by weight to about 300 parts by weight, based on 100 parts by weight of the ionic liquid. For example, the amount of the lithium salt in the solid electrolyte may be from about 40 parts by weight to about 200 parts, and in some embodiments, from about 50 by weight parts to about 150 parts by weight, and in some embodiments, from about 70 parts by weight to about 130 parts by weight, and in some other embodiments, from about 80 parts by weight to about 120 parts by weight, based on 100 parts by weight of the ionic liquid. When the amount of the lithium salt of the solid electrolyte is too small (e.g., less than 33 parts by weight, based on 100 parts by weight of the ionic liquid), due to reduced ionic conductivity of lithium ions, a lithium battery including the solid electrolyte may have deteriorated cycle characteristics. On the other hand, when the amount of the lithium salt in the solid electrolyte is too large (e.g., greater than 300 parts by weight, based on 100 parts by weight of the ionic liquid), it may not be possible to form a solid electrolyte membrane.

For example, the inclusion of the inorganic particle in the solid electrolyte may improve barrier characteristics of the solid electrolyte. Barrier characteristics refer to the ability to block the passage of a gas and/or water vapor through the solid electrolyte. Inorganic particles dispersed in the solid electrolyte may form a tortuous path to inhibit diffusion of oxygen, so that the solid electrolyte may have barrier characteristics. Therefore, the solid electrolyte may be impermeable to a gas such as oxygen, thus the solid electrolyte may effectively protect the positive electrode, such as lithium metal, from the external environment.

The inorganic particle in the solid electrolyte may be electrochemically inert. In other words, the electrochemically inert inorganic particle in the solid electrolyte is distinguished from an electrode active material. For example, the inorganic particle of the solid electrolyte is not oxidized or reduced during operation of the battery, and thus an oxidation number of the inorganic particle may not change due to intercalation and deintercalation of lithium ions or electrons. The inorganic particle of the solid electrolyte may include a non-carbonaceous inorganic particle and/or a nonmetallic inorganic particle. The inorganic particle of the solid electrolyte may be an electrical insulator. The inorganic particle of the solid electrolyte is distinguished from a conducting agent having electrical conductivity that is used in an electrode.

For example, the inorganic particle of the solid electrolyte may include at least one selected from a metal oxide, a metal nitride, a metal oxynitride, a metal carbide, a carbon oxide, a carbonaceous material, and an organic-inorganic composite. For example, the inorganic particle may include at least one selected from SiO₂, TiO₂, Al₂O₃, AlN, SiC, BaTiO₃, graphite oxide, graphene oxide, a metal organic framework (MOF), a polyhedral oligomeric silsesquioxane (POSS), Li₂CO₃, Li₃PO₄, Li₃N, Li₃S₄, Li₂O, and montmorillonite. However, embodiments are not limited thereto. Any inorganic particle suitable for use in a solid electrolyte may be used. The inorganic particle of the solid electrolyte may have a size of less than 100 nanometers (nm). For example, the inorganic particle of the solid electrolyte may have a size of less than or equal to about 50 nm, and in some embodiments, less than or equal to about 40 nm, and in some embodiments, less than or equal to about 30 nm, and in some other embodiments, less than or equal to about 2 nm. For example, the inorganic particle of the solid electrolyte may have a particle size of about 1 nm to about 80 nm, or about 2 nm to about 50 nm, or about 5 nm to about 20 nm. The term “particle size” as used herein, may refer to a diameter of the inorganic particle.

The amount of the inorganic particle in the solid electrolyte may be from about 0.1 part by weight to about 15 parts by weight, based on 100 parts by weight of the ionic liquid. For example, the amount of the inorganic particle in the solid electrolyte may be from about 0.5 part by weight to about 10 parts by weight, and in some embodiments, from about 1 part by weight to about 10 parts by weight, and in some embodiments, from about 2 parts by weight to about 8 parts by weight, and in some other embodiments, about 3 parts by weight to about 7 parts by weight, based on 100 parts by weight of the ionic liquid. When the amount of the inorganic particle is within any of these ranges, a lithium battery including the solid electrolyte may have further improved cycle characteristics. For example, physical properties of the solid electrolyte membrane, including thickness, ionic conductivity, oxygen permeability, and physical stability of the solid electrolyte, may be easily controlled by adjusting the amount of the inorganic particle in the solid electrolyte.

For example, the inorganic particle of the solid electrolyte may be a porous particle. For example, the inorganic particle may have a Brunauer-Emmett-Teller (BET) specific surface area of greater than or equal to about 300 square meters per gram (m²/g). For example, the inorganic particle may have a BET specific surface area of greater than or equal to about 400 m²/g, and in some embodiments, greater than or equal to about 500 m²/g, and in some embodiments, greater than or equal to about 600 m²/g, and in some other embodiments, greater than or equal to about 700 m²/g. In some embodiments, the inorganic particle of the solid electrolyte may be non-porous. For example, the inorganic particle of the solid electrolyte may have a spherical shape. However, the shape of the inorganic particle is not limited thereto. The inorganic particle may have any structure or shape that may facilitate an improvement in the barrier characteristics of the solid electrolyte. For example, the inorganic particle may be a non-porous spherical particle.

For example, the solid electrolyte may have an ionic conductivity of greater than or equal to about 1×10⁻⁴ Siemens per centimeter (S/cm), as measured at a temperature of about 25° C. For example, the solid electrolyte may have an ionic conductivity of greater than or equal to about 3×10⁻⁴ S/cm, and in some embodiments, greater than or equal to about 5×10⁻⁴ S/cm, greater than or equal to about 6×10⁻⁴ S/cm, and in some embodiments, greater than or equal to about 1×10⁻³ S/cm, and in some other embodiments, greater than or equal to about 1×10⁻² S/cm, as measured at temperature of about 25° C.

According to another aspect of the present disclosure, a lithium battery includes a positive electrode, a negative electrode, and an electrolyte layer disposed between the positive electrode and the negative electrode, where the electrolyte layer includes the solid electrolyte disclosed herein. By including the solid electrolyte in the lithium battery, the lithium battery may be flexible and have improved cycle characteristics.

For example, the electrolyte layer of the lithium battery may be a solid electrolyte membrane including the disclosed solid electrolyte. In other words, the lithium battery may comprise a positive electrode/electrolyte membrane/negative electrode structure. The lithium battery may further include an inorganic composite layer disposed on a surface of the electrolyte layer, where the inorganic composite layer includes an inorganic particle. The inorganic composite layer may be a layer which includes only inorganic particles (e.g., consists of inorganic particles), or may be a composite layer including both inorganic particles and the solid electrolyte. The inorganic composite layer may disposed be on one surface of the electrolyte layer or may be disposed on both a first surface and an opposite second surface of the electrolyte layer. The inorganic composite layer may be disposed between the electrolyte layer and the negative electrode and may be in contact with the negative electrode thereby suppressing formation of lithium dendrite on a surface of the negative electrode and improving and maintaining the ionic conductivity of the negative electrode.

The inorganic particle in the inorganic composite layer may have suitable ionic conductivity. For example, the inorganic particle having ionic conductivity may be at least one selected from Cu₃N, Li₃N, LiPON, Li₃PO₄.Li₂S.SiS₂, Li₂S.GeS₂.Ga₂S₃, Li₂O.11Al₂O₃, Na₂O.11Al₂O₃, (Na₁₋ₐLiₐ)₁₊ₓTi₂₋ₓAlₓ(PO₄)₃ (wherein 0.1≦x≦0.9 and 0≦a≦1), Li₁₊ₓHf₂₋ₓAlₓ(PO₄)₃ (wherein 0.1≦x≦0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, a sodium silicate, Li_{0.3}La_{0.5}TiO₃, Na₅MSi₄O₁₂ (wherein M is a rare-earth element such as Nd, Gd, or Dy), Li₅ZrP₃O₁₂, Li₅TiP₃O₁₂, Li₃Fe₂P₃O₁₂, Li₄NbP₃O₁₂, Li₁₊ₓ(M_{b}Al_{c}Ga_{d})ₓ(Ge_{1-y}Ti_{y})₂₋ₓ(PO₄)₃ (wherein 0<x≦0.8, 0≦y≦1, M may be Nd, Sm, Eu, Gd, Tb, Dy, Ho, Er, Tm, or Yb, and 0≦b≦1, 0≦c≦1, and 0≦d≦1), Li_{1+x+y}QₓTi₂₋ₓSi_{y}P_{3-y}O₁₂ (wherein 0<x≦0.4, 0<y≦0.6, and Q may be Al or Ga), Li₆BaLa₂Ta₂O₁₂, Li₇La₃Zr₂O₁₂, Li₅La₃Nb₂O₁₂, Li₅La₃M₂O₁₂ (wherein M may be Nb or Ta), and Li₇₊ₓAₓLa₃₋ₓZr₂O₁₂ (wherein 0<x<3, and A may be Zn).

For example, the electrolyte layer of the lithium battery may include a composite electrolyte membrane including a separator and a solid electrolyte may be impregnated in the separator. The composite electrolyte membrane formed by the impregnation of the solid electrolyte in a porous membrane such as the separator may improve durability of the electrolyte layer of the lithium battery. The separator may be any separator suitable for use in a lithium battery, and the separator may include a polymer impermeable to a gas. The gas may be at least one of oxygen, nitrogen, and carbon dioxide. A detailed description of the separator will be provided later in connection with the description of a lithium ion battery.

For example, the electrolyte layer of the lithium battery may have a multilayer structure including a first electrolyte layer and a second electrolyte layer, wherein the first electrolyte layer includes a separator and the second electrolyte layer includes a solid electrolyte. For example, the electrolyte layer of the lithium battery may include a plurality of first electrolyte layers and a plurality of second electrolyte layers. For example, the second electrolyte layer in the above-described multilayer structure as may contact the negative electrode or the positive electrode of the lithium battery. For example, the lithium battery may have a structure of positive electrode/first electrolyte layer/second electrolyte layer/negative electrode, or a structure of positive electrode/second electrolyte layer/first electrolyte layer/negative electrode.

For example, the separator of the first electrolyte layer may be impregnated with at least one electrolyte selected from a liquid electrolyte and a solid electrolyte. A detailed description of the liquid electrolyte will be provided later in connection with a lithium battery. For example, the solid electrolyte may be a solid electrolyte including an inorganic particle having ionic conductivity, or a solid electrolyte including a polymer. The solid electrolyte impregnated in the separator of the first electrolyte layer may be the same or different as the solid electrolyte impregnated in the separator of the second electrolyte layer.

For example, the lithium battery may include at least one folded portion. The positive electrode, negative electrode, and electrolyte layer of the lithium battery may be flexible so that the lithium battery may be foldable. Due to the at least one folded portion of the lithium battery, it may be easy to form the lithium battery in various shapes.

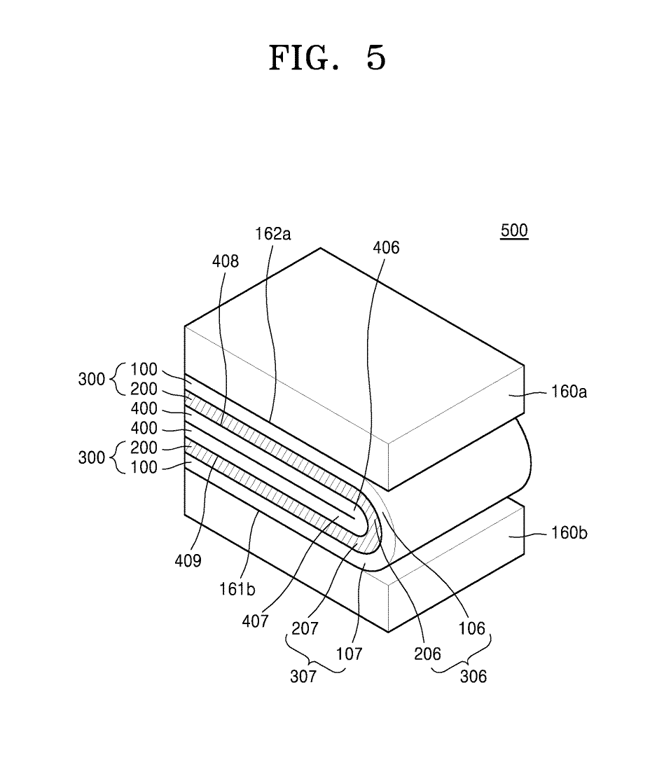

Referring to FIG. 5, a lithium air battery 500 according to an embodiment may include a positive electrode-membrane assembly 300 including a positive electrode 100 and a solid electrolyte membrane 200, wherein the positive electrode-membrane assembly 300 may have at least one folded portion 306, 307. A negative electrode 400 may have at least one folded portion 406, 407. The positive electrode 100 may have at least one folded portion 106, 107, and the solid electrolyte membrane 200 may have at least one folded portion 206, 207.

Referring to FIG. 5, in the lithium battery 500, the positive electrode-membrane assembly 300 and the negative electrode 400 may be folded at an angle of about 180° such that a half of an inner surface region of the folded portion of the negative electrode 400 contacts the other half of the inner surface region of the folded portion of the negative electrode 400. Outer surface regions 408 and 409 of the folded negative electrode 400 may both contact the positive electrode-membrane assembly 300 to allow transport of active metal ions through outer surface regions 408 and 409 to the positive electrode membrane assembly 300. Accordingly, the lithium battery 500 may have improved discharge capacity and energy density as compared to a prior art electrochemical battery having the same weight in which active metal ions are transferred through only one surface of a negative electrode.

Referring to FIG. 5, the lithium battery 500 may include a plurality of gas diffusion layers 160a and 160b that are separated from one another in a thickness direction of the lithium battery 500. Opposite outer surface regions of the positive electrode 100 folded at an angle of about 180° may respectively contact a first surface 162a of the gas diffusion layer 160a and a first surface 161b of the gas diffusion layer 160b, wherein the first surfaces 162a and 161b face each other. The solid electrolyte membrane 200 and the positive electrode 100 may each be folded at an angle of about 180° in the same pattern so that the solid electrolyte membrane 200 and the positive electrode 100 contact each other. The negative electrode 400 may be folded at an angle of about 180° in the same pattern as the solid electrolyte membrane 200 so that the negative electrode 400 and the solid electrolyte membrane 200 contact each other. The negative electrode 400 may be folded at an angle of about 180° such that at least two portions of the negative electrode 400 overlap between the gas diffusion layers 160a and 160b. Although not illustrated, a plurality of lithium batteries, each having the same structure as the lithium battery 500, may be stacked on one another to form a lithium battery module.

For example, the positive electrode-membrane assembly 300 and the negative electrode 400 of the lithium battery 500 may be folded multiple times in the thickness direction thereof to form a 3-dimensional (3D) lithium battery.

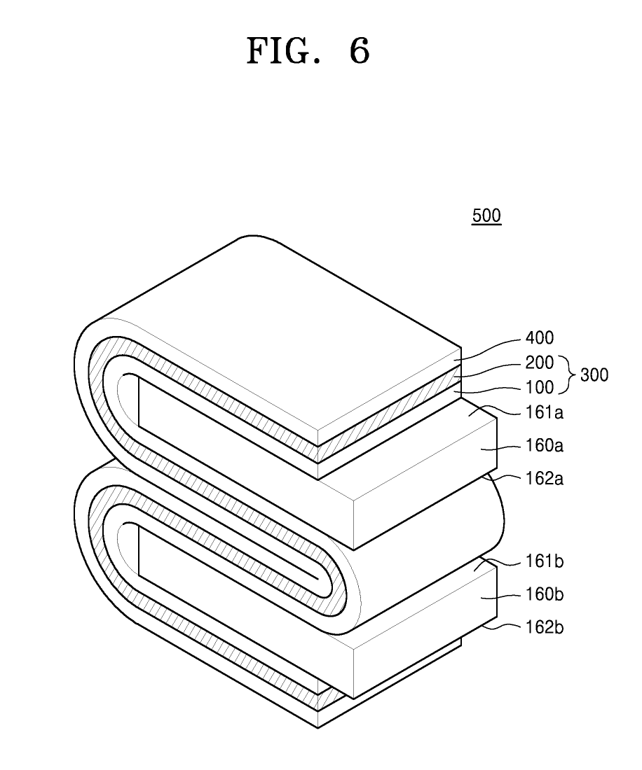

Referring to FIG. 6, a 3D lithium battery 500 according to an embodiment may include a plurality of gas diffusion layers 160a and 160b separated from one another in a thickness direction of the 3D lithium battery 500, A positive electrode-membrane assembly 300 including a positive electrode 100, may be repeatedly folded at an angle of about 180° such that the positive electrode 100 may respectively contact first surfaces 161a and 162a of the gas diffusion layer 160a and opposite second surfaces 161b and 162b of the gas diffusion layer 160b. A negative electrode 400 may be repeatedly folded at an angle of about 180° in the same pattern as the positive electrode-membrane assembly 300 such that portions of the negative electrode 400 contact a solid electrolyte membrane 200 of the positive electrode-membrane assembly 300. The negative electrode 400 may be folded at an angle of about 180° between the two adjacent gas diffusion layers 160a and 160b and overlap therebetween. In the 3D lithium battery 500, the position of the folds, the number of folds, and the folding direction of the folds of the positive electrode-membrane assembly 300 and the negative electrode 400 may be appropriately selected depending on the shape of the 3D lithium battery. Although not illustrated, a plurality of 3D lithium batteries each having the same structure as the 3D lithium battery 500 may be stacked on one another to form an electrochemical battery module.

A lithium battery according to any of the embodiments may be a lithium-air battery or a lithium ion battery. For example, the lithium battery 500 of FIG. 5 or 6 may be a lithium-air battery.

A method of preparing a composite electrolyte membrane comprises providing a separator; and impregnating the separator with a solid electrolyte to prepare the composite electrolyte membrane, wherein the solid electrolyte comprises an ionic liquid, a lithium salt, an inorganic particle, and a polymer, wherein an amount of the ionic liquid is greater than or equal to about 33 parts by weight, based on 100 parts by weight of the polymer. The method of preparing a lithium battery comprises providing a positive electrode; providing a negative electrode; and disposing an electrolyte layer between the positive electrode and the negative electrode to prepare the lithium battery, the electrolyte layer comprising a solid electrolyte, wherein the solid electrolyte comprises an ionic liquid, a lithium salt, an inorganic particle, and a polymer, wherein an amount of the ionic liquid is greater than or equal to about 33 parts by weight, based on 100 parts by weight of the polymer. The method of preparing a lithium battery further comprises disposing an inorganic composite layer between the electrolyte layer and the negative electrode. In the method of preparing a lithium battery, the electrolyte layer is prepared by providing a separator, and impregnating the separator with the solid electrolyte. In the method of preparing a lithium battery, the electrolyte layer has a multilayer structure comprising a first electrolyte layer comprising a separator and a second electrolyte layer comprising the solid electrolyte.

### Lithium-Air Battery

For example, a lithium battery according to any of the embodiments may be a lithium-air battery.

A lithium-air battery may be manufactured as follows.

First, a positive electrode is prepared. For example, the positive electrode may be manufactured as follows. A conductive agent such as a carbonaceous material or metallic material is mixed with a solvent to prepare electrode positive electrode slurry. The positive electrode slurry may be coated on a surface of a positive electrode current collector and dried, and optionally, followed by press-molding against the current collector to improve the density of the positive electrode. The current collector may be a gas diffusion layer. In some embodiments, the air electrode slurry may be coated on a surface of a separator or a solid electrolyte membrane and dried, optionally followed by press-molding against the separator or solid electrolyte membrane to improve the density of the positive electrode.

The positive electrode slurry may include a binder. The binder may include at least one of a thermoplastic resin and a thermocurable resin, e.g., a thermoset. For example, the binder may be at least one selected from polyethylene, polypropylene, PTFE, PVdF, styrene-butadiene rubber, a tetrafluoroethylene-perfluoroalkyl vinyl ether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoroethylene copolymer, and an ethylene-acrylic acid copolymer. However, embodiments are not limited thereto. Any binder suitable for use in a positive electrode may be used.

A porous structure having a matrix or mesh-shaped form may be used as the current collector to facilitate diffusion of oxygen. A porous metal plate made of, for example, stainless steel, nickel, or aluminum may also be used as the current collector. Materials for the current collector are not particularly limited, and any materials suitable for use as current collectors available may be used. The current collector may be coated with an anti-oxidation metal or alloy film to prevent oxidation of the current collector.

Optionally, the air electrode slurry may include a catalyst for oxidation/reduction of oxygen, and may also include a conductive material. Optionally, the air electrode slurry may include a lithium oxide.

The catalyst for facilitating oxygen/reduction of oxygen added to the positive electrode of the lithium-air battery may be at least one selected from metal-based catalysts, such as platinum (Pt), gold (Au), silver (Ag), palladium (Pd), ruthenium (Ru), rhodium (Rh), and osmium (Os); oxide-based catalysts, such as manganese oxide, iron oxide, cobalt oxide, and nickel oxide; and organic metal-based catalysts, such as cobalt phthalocyanine. Any catalysts suitable for oxidation and reduction of oxygen available may be used.

The catalyst may be supported on a support. Non-limiting examples of the support include at least one selected from oxide, zeolite, clay mineral, and carbon. The oxide may include at least one oxide of alumina, silica, zirconium oxide, and titanium dioxide. The oxide may be an oxide that includes at least one metal selected from the group consisting of cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), and tungsten (W). Non-limiting examples of the carbon include at least one selected from carbon black, such as Ketjen black, acetylene black, channel black, and lamp black; graphite, such as natural graphite, artificial graphite, and expanded graphite; activated carbon; and carbon fibers. Any materials suitable for use as supports may be used.

Next, a negative electrode is prepared.

The negative electrode may be an alkali metal thin film, for example, a lithium metal thin film or lithium metal-based alloy thin film. For example, the lithium metal-based alloy may be an alloy of lithium with, for example, aluminum, tin, magnesium, indium, calcium, titanium, or vanadium.

A separator may be disposed between the negative electrode and the positive electrode. The separator may be any separator having a composition suitable for use in a lithium-air battery. For example, the separator may be a polymeric non-woven fabric such as polypropylene non-woven fabric or polyphenylene sulfide non-woven fabric; a porous film of an olefin-based resin such as polyethylene or polypropylene; or a combination of at least two thereof.

An electrolyte layer including a solid electrolyte according to any of the above-described embodiments may be disposed between the positive electrode and the negative electrode.

A lithium-air battery according to any of the above-described embodiments may be available as a primary battery or a secondary battery. The lithium-air battery may have any of various shapes, and in some embodiments, may have a shape like a coin, a button, a sheet, a stack, a cylinder, a plane, or a horn. The lithium-air battery may be s a large battery for electric vehicles.

The term “air” used herein is not limited to atmospheric air, and for convenience, may refer to a combination of gases including oxygen, or pure oxygen gas. This broad definition of “air” also applies to other terms, including “air battery” and “air electrode.”

The term “substituted” as used herein means substitution with a halogen atom, a C₁-C₂₀ alkyl group substituted with a halogen atom (e.g., —CCF₃, —CHCF₂, —CH₂F, —CCl₃, or the like), a hydroxyl group, a nitro group, a cyano group, an amino group, an amidino group, a hydrazine, a hydrazone, a carboxyl group or a salt thereof, a sulfonic acid or a salt thereof, a phosphoric acid or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, or a C₆-C₂₀ heteroarylalkyl group.

“Alkyl” as used herein means a straight or branched chain, saturated, monovalent hydrocarbon group (e.g., methyl or hexyl).

“Aryl” means a monovalent group formed by the removal of one hydrogen atom from one or more rings of an arene (e.g., phenyl or napthyl). alkenyl

“Cycloalkyl” means a monovalent group having one or more saturated rings in which all ring members are carbon (e.g., cyclopentyl and cyclohexyl).

“Alkylene oxide” means an aliphatic C2 to C100 epoxide, for example ethylene oxide, propylene oxide or butylene oxide.

“Alkoxy” means an alkyl group that is linked via an oxygen (i.e., alkyl-O—), for example methoxy, ethoxy, and sec-butyloxy groups.

“Aryloxy” means an aryl moiety that is linked via an oxygen (i.e., —O-aryl). An aryloxy group includes a C6 to C30 aryloxy group, and specifically a C6 to C18 aryloxy group. Non-limiting examples include phenoxy, naphthyloxy, and tetrahydronaphthyloxy.

The prefix “hetero” means that the compound or group includes at least one a heteroatom (e.g., 1, 2, or 3 heteroatom(s)), wherein the heteroatom(s) is each independently N, O, S, Si, or P.

### Lithium Ion Battery

For example, a lithium battery according to any of the embodiments may be a lithium ion battery.

A lithium ion battery may be manufactured as follows.

First, a negative electrode is prepared.

The negative electrode may be a lithium metal thin film. In some embodiments, the negative electrode may include a negative electrode current collector and a negative active material layer disposed on the current collector. For example, the negative electrode may include a conductive substrate as a current collector and a lithium metal thin film disposed on the conductive substrate. The lithium metal thin film and the current collector may be integrated together to form a single body.

The current collector of the negative electrode may include at least one selected from stainless steel, copper, nickel, iron, and cobalt. However, embodiments are not limited thereto. Any metallic substrate with good electrical conductivity may be used. For example, the current collector may be a conductive metal oxide substrate or a conductive polymer substrate. The structure of the current collector is not limited, and the current collector may have any of a variety of structures including, for example, a substrate completely coated with a conductive material, and an insulating substrate having at least one surface which is coated with a conductive metal, a conductive metal oxide, or a conductive polymer. For example, the current collector may be a flexible substrate. Accordingly, the current collector may be easily folded or unfolded back to its original shape.

The negative electrode may further include a negative active material in addition to the lithium metal. The negative electrode may include an alloy of lithium metal with a negative active material, a composite of lithium metal with a negative active material, or a mixture of lithium metal with a negative active material.

A negative active material that may be used in the negative electrode may be, for example, at least one selected from a metal alloyable with lithium, a transition metal oxide, a non-transition metal oxide, and a carbonaceous material.

Examples of the metal alloyable with lithium include at least one selected from Si, Sn, Al, Ge, Pb, Bi, Sb, a Si—Y′ alloy (where Y′ is at least one selected from an alkali metal, an alkali earth metal, a Group 13 element, a Group 14 element, a transition metal, and a rare earth element, and Y′ is not Si), and a Sn—Y′ alloy (where Y′ is at least one selected from an alkali metal, an alkali earth metal, a Group 13 element, a Group 14 element, a transition metal, and a rare earth element, and Y′ is not Sn). In some embodiments, Y′ may be at least one selected from magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), and polonium (Po). In some embodiments, Y may be at least one selected from magnesium (Mg), calcium (Ca), strontium (Sr), barium (Ba), radium (Ra), scandium (Sc), yttrium (Y), titanium (Ti), zirconium (Zr), chromium (Cr), molybdenum (Mo), tungsten (W), iron (Fe), lead (Pb), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), and polonium (Po).

Examples of the transition metal oxide include at least one selected from a lithium titanium oxide, a vanadium oxide, and a lithium vanadium oxide.

Examples of the non-transition metal oxide include at least one selected from SnO₂ and SiOₓ (wherein 0<x<2).

Examples of the carbonaceous material include at least one selected from crystalline carbon and amorphous carbon. Examples of the crystalline carbon include graphite, such as natural graphite or artificial graphite that are in shapeless, plate, flake, spherical, or fibrous form. Examples of the amorphous carbon include at least one selected from soft carbon (carbon sintered at low temperatures), hard carbon, meso-phase pitch carbides, and sintered cokes.

In some embodiments, the negative electrode may include an alternative negative active material instead of lithium metal. The negative electrode may be manufactured using a negative active material composition including an alternative negative active material instead of lithium metal, a conducting agent, a binder, and a solvent

For example, after a negative active material composition is prepared, the negative active material composition may be directly coated on a current collector to obtain a negative electrode plate. In some embodiments, the negative active material composition may be cast on a separate support to form a negative active material film, which may then be separated from the support and laminated on a current collector to obtain a negative electrode plate with the negative active material film thereon. The negative electrode may have any one of a variety of shapes, and is not limited to the above-described structures. For example, the negative electrode may be prepared by inkjet printing a negative active material ink including, for example, a negative active material and an electrolyte solution onto a current collector.

The negative active material may be in powder form. The negative active material in powder form may be applicable to the negative active material composition or negative active material ink.

The conducting agent may be carbon black, graphite particulates, or the like. However, embodiments are not limited thereto. Any material suitable for use as a conducting agent may be used.

Examples of the binder include at least one selected from a vinylidene fluoride/hexafluoropropylene copolymer, PVDF, polyacrylonitrile, polymethylmethacrylate, polytetrafluoroethylene, and a styrene butadiene rubber polymer. However, embodiments are not limited thereto. Any material suitable for use as a binding agent may be used.

Examples of the solvent include at least one selected from N-methyl-pyrrolidone, acetone, and water. However, embodiments are not limited thereto. Any material suitable for use as a solvent may be used.

The amounts of the negative active material, the conducting agent, the binder, and the solvent may be in ranges that are used in lithium batteries and may be determined by the person of skill in the art without undue experimentation. At least one of the conducting agent, the binder, and the solvent may be omitted according to the use and the structure of a lithium battery.

Next, a positive electrode is prepared as follows.

The positive electrode may be prepared in the same manner as the negative active material composition, except that a positive active material is used instead of a negative active material. Examples of a conducting agent, a binder, and a solvent used for the positive active material composition may be the same as those used for the negative active material composition.

In particular, a positive active material, a gel electrolyte, a conducting agent, a binder, and a solvent may be mixed together to prepare a positive active material composition. In some embodiments, a positive active material, a conducting agent, and a gel electrolyte may be mixed together to prepare a positive active material composition. The positive active material composition may be directly coated on an aluminum current collector and dried to obtain a positive electrode plate having a positive active material film disposed thereon. In some embodiments, the positive active material composition may be cast on a separate support to form a positive active material film, which may then be separated from the support and laminated on an aluminum current collector to obtain a positive electrode plate with the positive active material layer disposed thereon.

The positive active material is not limited, and may be for example, a lithium-containing metal oxide. In some embodiments, the positive active material may be at least one selected from a composite oxide of lithium with a metal selected from at least one of Co, Mn, and Ni. In some embodiments, the positive active material may be at least one compound selected from the following formulae: LiₐA_{1-b}B¹_{b}D₂ (wherein 0.90≦a≦1.8, and 0≦b≦0.5); LiₐE_{1-b}B¹_{b}O_{2-c}D_{c} (wherein 0.90≦a≦1.8, 0≦b≦0.5, and 0≦c≦0.05); LiE_{2-b} B¹_{b}O_{4-c}D_{c} (wherein 0≦b≦0.5, and 0≦c≦0.05); LiₐNi_{1-b-c}Co_{b}B¹_{c}D_{α} (wherein 0.90≦a≦1.8, 0≦b≦0.5, 0≦c≦0.05, and 0<α≦2); LiₐNi_{1-b-c}CO_{b}B¹_{c}O_{2-α}F¹_{α} (wherein 0.90≦a≦1.8, 0≦b≦0.5, 0≦c≦0.05, and 0<α<2); LiₐNi_{1-b-c}CO_{b} B¹_{c}O_{2-α}F¹₂ (wherein 0.90≦a≦1.8, 0≦b≦0.5, 0≦c≦0.05, and 0<α<2); LiₐNi_{1-b-c}Mn_{b} B¹_{c}D_{α} (wherein 0.90≦a≦1.8, 0≦b≦0.5, 0≦c≦0.05, and 0<α≦2); LiₐNi_{1-b-c}Mn_{b} B¹_{c}O_{2-α}F¹_{α} (wherein 0.90≦a≦1.8, 0≦b≦0.5, 0≦c≦0.05, and 0<α<2); LiₐNi_{1-b-c}Mn_{b} B¹_{c}O_{2-α}F¹₂ (wherein 0.90≦a≦1.8, 0≦b≦0.5, 0≦c≦0.05, and 0<α<2); LiₐNi_{b}E_{c}G_{d}O₂ (wherein 0.90≦a≦1.8, 0≦b≦0.9, 0≦c≦0.5, and 0.001≦d≦0.1); LiₐNi_{b}Co_{c}Mn_{d}GeO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8, 0.001≦b≦0.1); LiₐCoG_{b}O₂ (wherein 0.90≦a≦1.8, and 0.001≦b≦0.1); LiₐMnG_{b}O₂ (wherein 0.90≦a≦1.8, and 0.001≦b≦0.1); LiₐMn₂G_{b}O₄ (wherein 0.90≦a≦1.8, and 0.001≦b≦0.1); QO₂; QS₂; LiQS₂; V₂O₅; LiV₂O₅; LiI¹O₂; LiNiVO₄; Li_{(3-f)}J₂(PO₄)₃ (wherein 0≦f≦2); Li_{(3-f)}Fe₂(PO₄)₃ (wherein 0≦f≦2); and LiFePO₄.

In the formulae above, A may be at least one selected from nickel (Ni), cobalt (Co), and manganese (Mn); B¹ may be at least one selected from aluminum (Al), nickel (Ni), cobalt (Co), manganese (Mn), chromium (Cr), iron (Fe), magnesium (Mg), strontium (Sr), vanadium (V), and a rare earth element; D¹ may be at least one selected from oxygen (O), fluorine (F), sulfur (S), and phosphorus (P); E may be at least one selected from cobalt (Co) and manganese (Mn); F¹ may be at least one selected from fluorine (F), sulfur (S), and phosphorus (P); G may be at least one selected from aluminum (Al), chromium (Cr), manganese (Mn), iron (Fe), magnesium (Mg), lanthanum (La), cerium (Ce), strontium (Sr), and vanadium (V); Q is at least one selected from titanium (Ti), molybdenum (Mo), and manganese (Mn); I¹ is at least one selected from chromium (Cr), vanadium (V), iron (Fe), scandium (Sc), and yttrium (Y); and J may be at least one selected from vanadium (V), chromium (Cr), manganese (Mn), cobalt (Co), nickel (Ni), and copper (Cu).

In some embodiments, the positive active material may be at least one selected from LiCoO₂, LiMnₓO₂ₓ (wherein x=1 or 2), LiNi₁₋ₓMnₓO₂ₓ (wherein 0<x<1), Ni_{1-x-y}CoₓMn_{y}O₂ (wherein 0≦x≦0.5 and 0≦y≦0.5), and LiFePO₄.

The compounds listed above as positive active materials may have a surface coating layer (hereinafter, also referred to as “coating layer”). Alternatively, a mixture of a compound without a coating layer and a compound having a coating layer, the compounds being selected from the compounds listed above, may be used. In some embodiments, the coating layer may include at least one selected from an oxide, hydroxide, oxyhydroxide, oxycarbonate, and hydroxycarbonate of any one of the coating elements listed above. In some embodiments, the compounds for the coating layer may be amorphous or crystalline. In some embodiments, the coating element for the coating layer may be at least one selected from magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), and zirconium (Zr). In some embodiments, the coating layer may be formed on the positive active material using any method that does not adversely affect the physical properties of the positive active material. For example, the coating layer may be formed using a spray coating method, or a dipping method. The coating methods are understood by those of ordinary skill in the art, and thus a detailed description thereof will be omitted.

Next, an electrolyte layer including a solid electrolyte according to any of the above-described embodiments may be disposed between the positive electrode and the negative electrode.

The electrolyte layer may include a separator. The separator for the electrolyte layer may be any separator that is used in lithium batteries. In some embodiments, the separator may have low resistance to migration of ions in an electrolyte and may have an excellent electrolyte-retaining ability. Examples of the separator include at least one selected from glass fiber, polyester, Teflon, polyethylene, polypropylene, and PTFE, each of which may be used as a non-woven or woven fabric. For example, a rollable separator including polyethylene or polypropylene may be used for a lithium ion battery. A separator with a good organic electrolytic solution-retaining ability may be used for a lithium ion polymer battery. For example, the separator may be manufactured in the following manner.

In some embodiments, a polymer resin, a filler, and a solvent may be mixed together to prepare a separator composition. Then, the separator composition may be directly coated on an electrode and dried to form the separator. In some embodiments, the separator composition may be cast on a support and then dried to form a separator film, which may then be separated from the support and laminated on an electrode to form the separator.

The polymer resin used to manufacture the separator may be any material that is used as a binder for electrode plates. Examples of the polymer resin include at least one selected from a vinylidenefluoride/hexafluoropropylene copolymer, PVDF, polyacrylonitrile, and polymethylmethacrylate.

Next, the separator may be impregnated with an electrolyte.

The electrolyte may be a liquid electrolyte or a solid electrolyte as described above. In some embodiments, the electrolyte may be an organic electrolyte solution. For example, the organic electrolyte solution may be prepared by dissolving a lithium salt in an organic solvent.

The organic solvent is not limited and may be any solvent available in the art. In some embodiments, the organic solvent may be at least one selected from propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxirane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, and dimethyl ether.

In some embodiments, the lithium salt may be any material suitable for use in an electrolyte. In some embodiments, the lithium salt may be at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently a natural number), LiCl, and LiI.

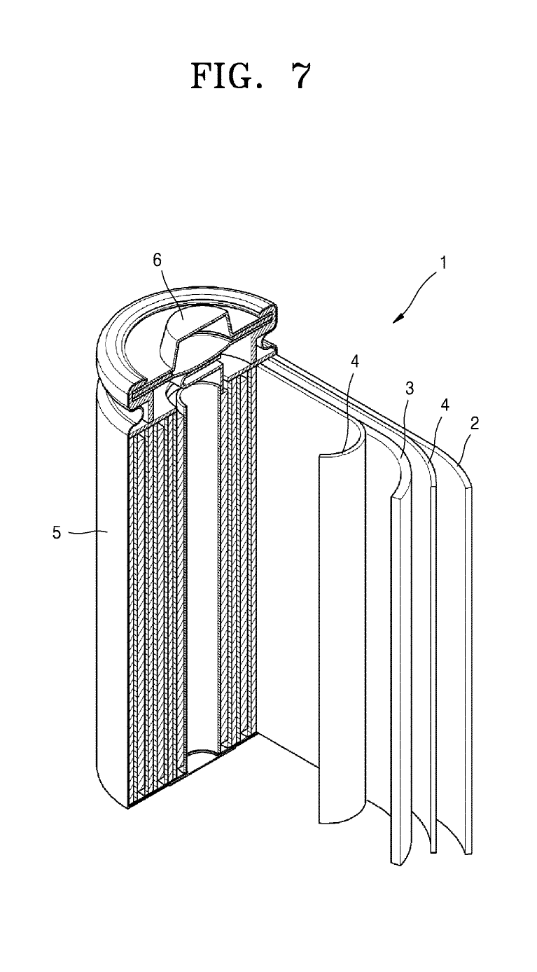

Referring to FIG. 7, a lithium ion battery 1 includes a positive electrode 3, a negative electrode 2, and a separator 4. In some embodiments, the positive electrode 3, the negative electrode 2, and the separator 4 may be wound or folded, and then sealed in a battery case 5. In some embodiments, the battery case 5 may be filled with an organic electrolyte solution and sealed with a cap assembly 6, thereby completing the manufacture of the lithium ion battery 1. In some embodiments, the battery case 5 may be a cylindrical type, a rectangular type, or a thin-film type. For example, the lithium ion battery 1 may be a large thin-film type battery. In some embodiments, the separator 4 may be a separator impregnated with a liquid electrolyte and/or a solid electrolyte. By using such a separator, the step of injecting an organic electrolyte solution into the separator is not needed.

In some embodiments, the separator may be disposed between the positive electrode and the negative electrode to form a battery assembly. In some embodiments, the battery assembly may be stacked in a bi-cell structure and impregnated with the organic electrolyte solution. In some embodiments, the resultant assembly may be put into a pouch and hermetically sealed, thereby completing the manufacture of a lithium ion polymer battery.

In some embodiments, a plurality of battery assemblies may be stacked to form a battery pack, which may be used in any device that benefits from high capacity and high output, for example, in a laptop computer, a smart phone, or an electric vehicle.

A lithium battery according to any of the embodiments may have improved lifetime characteristics and high rate characteristics, and thus may be used in an electric vehicle (EV), for example, in a hybrid vehicle such as a plug-in hybrid electric vehicle (PHEV). The lithium battery may also be applicable to the high-power storage field. For example, the lithium battery may be used in an electric bicycle or a power tool.

One or more embodiments of the present disclosure will now be described in detail with reference to the following examples. However, these examples are only for illustrative purposes and are not intended to limit the scope of the one or more embodiments of the present disclosure.

### EXAMPLES

### Preparation of Composite Electrolyte

### Example 1: Preparation of Solid Electrolyte Membrane Using PVDF, DEME, LiTFSI, 5 wt % of SiO₂, and No Separator

After PVDF as a polymer, N, N-diethyl-N-methyl-N-(2-methoxyethyl)ammonium bis(trifluoromethanesulfonyl)imide (DEME) as an ionic liquid, and LiTFSI as a lithium salt were added in a weight ratio of 1:1:1 to a N-methyl pyrrolidone (NMP) solvent, 5 parts by weight of SiO₂ particles (having an average diameter of about 7 nm to about 20 nm) as inorganic particles, based on 100 parts by weight of DEME, were added thereto and stirred for about 20 minutes to prepare a mixed solution. This mixed solution was poured into a Teflon dish, dried in a drying chamber at room temperature for 2 days, and further dried overnight under vacuum at a temperature of about 60° C. to thereby obtain a solid electrolyte membrane. This solid electrolyte membrane was a flexible free standing film and had a thickness of about 90 μm.

### Example 2: Preparation of 90 μm-Thick Solid Electrolyte Membrane Using PVDF, DEME, LiTFSI, 5 wt % of SiO₂, and a Separator

After PVDF as a polymer, DEME as an ionic liquid, and LiTFSI as a lithium salt were added in a weight ratio of 1:1:1 to an NMP solvent, 5 parts by weight of SiO₂ particles (having an average diameter of about 7 nm to 20 nm) as inorganic particles, based on 100 parts by weight of DEME, were added thereto and stirred for about 20 minutes to obtain a mixed solution. This mixed solution was impregnated into a porous separator (Celgard®), dried in a drying chamber at room temperature for 2 days, and further dried overnight under vacuum at about 60° C. to remove the solvent and thereby obtain a solid electrolyte membrane. This solid electrolyte membrane was a flexible free standing film and had a thickness of about 90 μm.

### Example 3: Preparation of 60 μm-Thick Solid Electrolyte Membrane Using PVDF, DEME, LiTFSI, 5 wt % of SiO₂, and a Separator

A solid electrolyte membrane was prepared in the same manner as in Example 2, except that the thickness of the solid electrolyte membrane was changed to about 60 μm.

### Example 4: Preparation of Solid Electrolyte Membrane Using PVDF, Pyrr16-TFSI, LiTFSI, 5 wt % of SiO₂, and a Separator

A solid electrolyte membrane was prepared in the same manner as in Example 2, except poly(diallyldimethylammonium)bis(trifluoromethanesulfonyl)imide (Pyrr16-TFSI) was used as an ionic liquid, instead of DEME. This solid electrolyte membrane was a flexible free standing film and had a thickness of about 90 μm.

### Comparative Example 1: Preparation of Solid Electrolyte Membrane Using PEO, LiTFSI, and Separator

16.32 grams (g) of polyethylene oxide (PEO) (weight average Mw=600,000, available from Aldrich, Cat. No. 182028) was dissolved in 150 mL of acetonitrile to prepare a PEO solution. Then, LiTFSi was added to the PEO solution in a mole ratio of [PEO] to [Li] of 18:1 and stirred to obtain a mixed solution. This mixed solution was impregnated into a porous separator (Celgard®), dried in a drying chamber at room temperature for 2 days, and further dried overnight under vacuum at about 60° C. to remove the solvent and thereby obtain a solid electrolyte membrane. This solid electrolyte membrane had a thickness of about 60 μm.

### Comparative Example 2: Preparation of Solid Electrolyte Membrane Using PVDF, DEME, LiTFSI, and a Separator (No SiO₂)

A solid electrolyte membrane was prepared in the same manner as in Example 3, except that SiO₂ as inorganic particles were not added. This solid electrolyte membrane was a flexible free standing film and had a thickness of about 60 μm.

### Comparative Example 3: Preparation of Solid Electrolyte Using DEME, LiTFSI, 5 wt % of SiO₂, and a Separator (No PVDF Polymer)

5 parts by weight of SiO₂ particles (having an average diameter of about 7 nm to 20 nm) as inorganic particles was added to 100 parts by weight of an ionic liquid electrolyte in which 1.0 M lithium bis(trifluoromethane sulfonyl) imide (LiTFSI) as a lithium salt was dissolved in DEME as an ionic liquid, and stirred for about 20 minutes to obtain a mixed solution. This mixed solution was impregnated into a porous separator (Celgard®), dried in a drying chamber at room temperature for 2 days, and further dried overnight under vacuum at about 60° C. to thereby obtain a solid electrolyte membrane. This solid electrolyte membrane had a thickness of about 60 μm.

### Comparative Example 4: Preparation of Solid Electrolyte Membrane Using PVDF, DEME, LiTFSI, 5 wt % of SiO₂, and Separator

A solid electrolyte membrane was prepared in the same manner as in Example 2, except that the weight ratio of PVDF, DEME, and LiTFSI was changed to 1:1:0.3. This solid electrolyte membrane was a flexible free standing film and had a thickness of about 60 μm.

### Comparative Example 5: Preparation of Electrolyte Using PVDF, DEME+LiTFSI, 5 wt % of SiO₂, and a Separator

The same electrolyte preparation processes as in Example 2 were performed, except that the weight ratio of PVDF, DEME, and LiTFSI was changed to 0.2:1:1. However, it was failed to form a solid electrolyte membrane, and instead, a liquid electrolyte composition was obtained.

### Manufacture of Lithium-Air Battery

### Example 5: Manufacture of Lithium-Air Battery

Manufacture of Positive Electrode

Carbon black (Printex®, available from Orion Engineered Chemicals, USA) as carbonaceous porous particles, an ionic liquid electrolyte in which 1.0 M LiTFSI as a lithium salt was dissolved in DEME as an ionic liquid, and PVDF as a binder (available from Sigma-Aldrich, powder, 35 μm) were prepared in a weight ratio of 1:3:0.2.

The binder and the ionic liquid electrolyte were mixed in a mortar, and then the carbonaceous porous material was added thereto to prepare a first paste.

This first paste was coated between two PTFE films, followed by pressing with a roll press to reduce the space between the PTFE films and thereby form a positive electrode as a free standing film. The positive electrode had a thickness of about 31 μm.

### Preparation of Electrolyte Membrane

A solid electrolyte membrane according to Example 1 was prepared.

### Manufacture of Lithium-Air Battery

Two positive electrodes (1 cm×3 cm) were arranged on a surface of the solid electrolyte membrane with a gap separation of about 0.5 mm to prepare a positive electrode-membrane laminate. This positive electrode-membrane laminate was then placed between PTFE films, hot-pressed at about 100° C. with a press, and subjected to natural cooling, thereby obtaining a positive electrode-membrane assembly as a free standing film.

The natural cooling after the hot pressing was performed for about 100 minutes to a temperature of about 80° C.

The positive electrode-membrane assembly was folded such that the two positive electrodes face each other, with a carbon paper (2 cm×3 cm, 25BA, available from SGL, Germany) as a gas diffusion layer between the two positive electrodes.

Prior to the folding process, a lithium metal (2.15 cm×3 cm) having a thickness of about 30 μm was arranged on a surface of the positive electrode-membrane assembly opposite to the positive electrodes, and the positive electrode-membrane assembly with the lithium metal thereon was folded such that the positive electrodes face each other, with the gas diffusion layer between the positive electrodes, and are symmetric to the lithium metal with respect to the solid electrolyte membrane of the positive electrode-membrane assembly, to thereby form a structure of gas diffusion layer/positive electrode/electrolyte membrane/negative electrode.

A portion of the gas diffusion layer that extends further than the positive electrode served as a positive electrode current collector. A copper (Cu) sheet was disposed as a negative electrode current collector on a surface of the lithium metal.

End plates were disposed on a surface of the negative electrode current collector and the other surface of the lithium metal negative electrode, respectively, thereby manufacturing a lithium-air battery.

### Examples 6 to 8

Lithium-air batteries were manufactured in the same manner as in Example 5, except that the solid electrolyte membranes of Examples 2 to 4 were used, instead of the solid electrolyte membrane of Example 1, respectively.

### Comparative Examples 6 to 9

Lithium-air batteries were manufactured in the same manner as in Example 4, except that the solid electrolyte membranes of Comparative Examples 1 to 4 were used, instead of the solid electrolyte membrane of Example 1, respectively.

### Comparative Example 10

The liquid electrolyte composition of Comparative Example 5 was used to manufacture a lithium-air battery. However, it failed to form an electrolyte membrane with the liquid electrolyte composition of Comparative Example 5 and was unable to form a lithium-air battery due to a short between the positive electrode and the negative electrode.

### Evaluation Example 1: Impedance Measurement

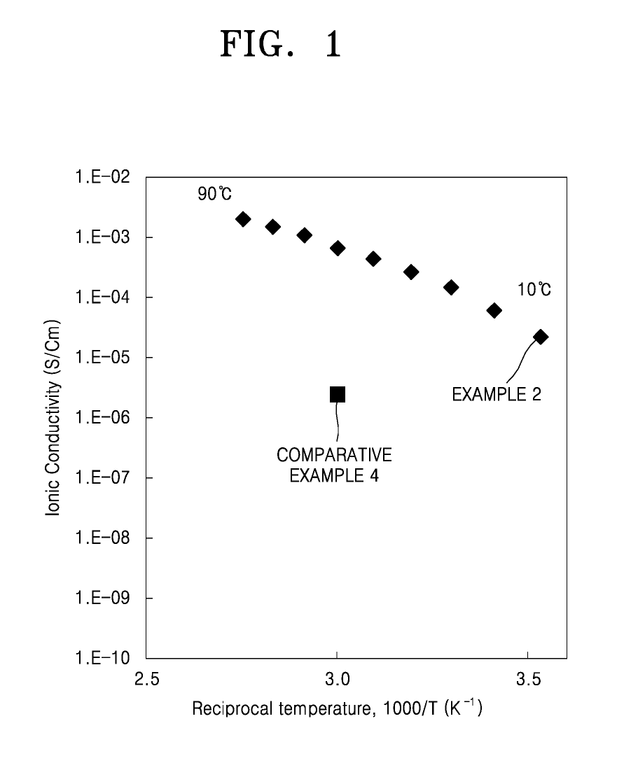

Impedance measurement was performed on the solid electrolyte membranes of Example 2 and Comparative Example 4 by a 2-probe method with an impedance analyzer (Solartron 1260A Impedance/Gain-Phase Analyzer) at about 25° C. at a current density of about 0.4 ampere per square centimeter (A/cm²) and an amplitude of about ±10 millivolt (mV) in a frequency range of about 0.1 hertz (Hz) to 10 kilohertz (KHz). Ionic conductivities of solid electrolyte membranes of Example 2 and Comparative Example 4 were measured based on the impedance measurement results. The results are shown in FIG. 1.

Referring to FIG. 1, the solid electrolyte membrane of Example 2 had a remarkably increased ionic conductivity compared to the solid electrolyte membrane of Comparative Example 4. For example, the solid electrolyte membrane of Example 2 had an ionic conductivity of about 6.6×10⁻⁴ S/cm at 25° C., while the solid electrolyte membrane of Comparative Example 4 had an ionic conductivity of about 2.5×10⁻⁶ S/cm at 25° C.

### Evaluation Example 2: Charge-Discharge Characteristics Evaluation

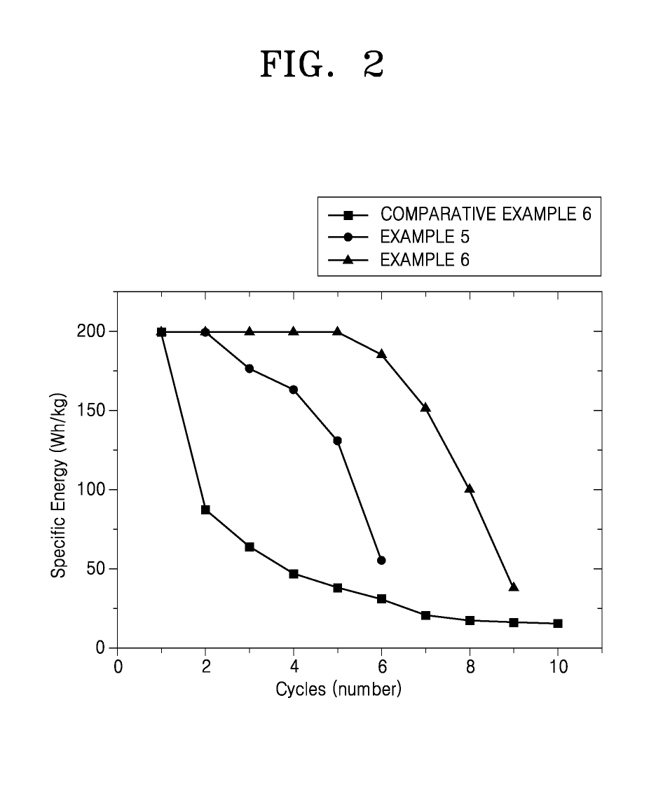

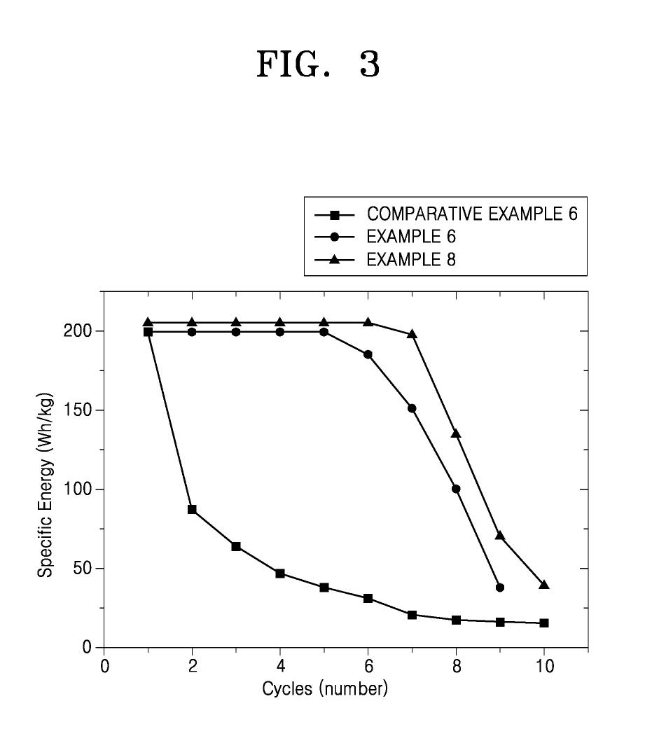

Each of the lithium-air batteries of Examples 5 to 8 and Comparative Examples 6 to 9 was discharged at about 60° C. under 1-atm oxygen atmosphere with a constant current of about 0.24 mA/cm² to an energy density of about 200 Wh/kg or a voltage of about 2.2 V (with respect to Li), and then charged with the same constant current to a voltage of about 4.3 V and then with the constant voltage to a charging current of about 0.02 mA/cm² (discharging-charging cycle). Changes in energy density with respect to the number of cycles are shown in FIGS. 2 and 3. The discharging of each lithium-air battery was cut off when the energy density (Output power, P=VI) reaches 200 Wh/kg before the discharge voltage reaches 2.2V, followed by charging. The discharging of each lithium-air battery was cut off when the discharge voltage reaches 2.2V before the energy density reaches 200 Wh/kg, followed by charging. In the units (Wh/kg) of energy density, kg indicates the measurement unit of the total weight of a lithium-air battery.

Referring to FIG. 2, the lithium-air batteries of Examples 5 and 6 were found to maintain an energy density of about 200 Wh/kg even after 2 or more cycles, while the energy density of the lithium-air battery of Comparative Example 6 was maintained at about 200 Wh/kg only at the 1^{st} cycle and was remarkably reduced from the 2^{nd} cycle. Therefore, the lithium-air batteries of Example 5 and 6 were found to have remarkably improved cycle characteristics, compared to the lithium-air battery of Comparative Example 6.

Although not illustrated in FIG. 2, the lithium-air battery of Comparative Example 8 failed to reach an energy density of about 200 Wh/kg at the 1^{st} cycle. Accordingly, the 1^{st} charging-discharging cycle failed to indicate that the lithium-air battery of Comparative Example 8 had poor cycle characteristics.

Referring to FIG. 3, the lithium-air batteries of Examples 6 and 8 were found to maintain an energy density of about 200 Wh/kg nearly after the 5^{th} cycle, while the energy density of the lithium-air battery of Comparative Example 6 was maintained at about 200 Wh/kg only at the 1^{st} cycle and was remarkably reduced from the 2^{nd} cycle. Therefore, the lithium-air batteries of Example 6 and 8 were found to have remarkably improved cycle characteristics, compared to the lithium-air battery of Comparative Example 6.

### Evaluation Example 3: Charge-Discharge Characteristics Evaluation

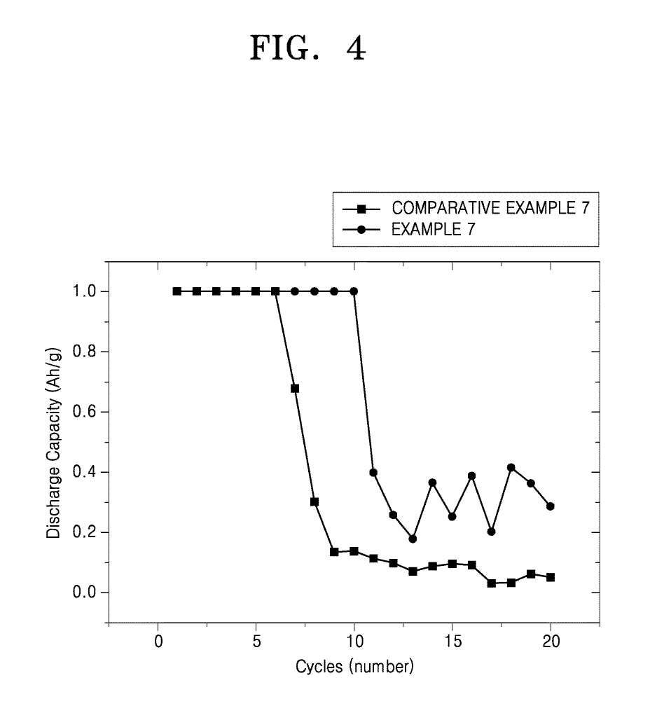

Each of the lithium-air batteries of Example 7 and Comparative Example 7 was discharged at about 60° C. under 1-atm oxygen atmosphere with a constant current of about 0.24 mA/cm² to a discharge capacity of about 1 Ah/g or a voltage of about 2.2 V (with respect to Li), and then charged with the same constant current to a voltage of about 4.3V and then with the constant voltage to a charging current of about 0.02 mA/cm² (charging-discharging cycle). Changes in energy density with respect to the number of cycles are shown in FIG. 4. The discharging of each lithium-air battery was cut off when the discharge capacity reaches 1 Ah/g before the discharge voltage reaches 2.2V, followed by charging. The discharging of each lithium-air battery was cut off when the discharge voltage reaches 2.2V before the discharge capacity reaches 1 Ah/g, followed by charging. In the unit (Ah/g) of discharge capacity, g indicates the weight of carbon black.

Referring to FIG. 4, the lithium-air battery of Example 7 was found to maintain a discharge capacity of about 1 Ah/g after the 10^{th} cycle, while the discharge capacity of the lithium-air battery of Comparative Example 7 was maintained at about 1 Ah/g up to the 6^{th} cycle and was remarkably reduced from the 7^{th} cycle. Therefore, the lithium-air battery of Example 7 was found to have improved cycle characteristics due to the addition of the inorganic particles. This cycle characteristics improvement is attributed to the improved ability to block oxygen by the addition of inorganic particles and consequentially suppressed side reaction on a surface of the lithium negative electrode.

As described above, according to the one or more embodiments, a lithium battery may have improved cycle characteristics by using a solid electrolyte according to any of the embodiments including excess of a polymer and excess of a lithium salt.

It should be understood that embodiments described herein should be considered in a descriptive sense only and not for purposes of limitation. Descriptions of features or aspects within each embodiment should be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A solid electrolyte comprising:
an ionic liquid;
a lithium salt;
an inorganic particle; and
a polymer,
wherein an amount of the ionic liquid is greater than or equal to about 33 parts by weight, based on 100 parts by weight of the polymer.

2. The solid electrolyte of claim 1, wherein the polymer comprises at least one selected from a non-alkylene oxide containing polymer and a non-ionic polymer.

3. The solid electrolyte of claim 1, wherein the polymer is at least one selected from polyethylene, polypropylene, polytetrafluoroethylene, polyvinylidene fluoride, styrene-butadiene rubber, a tetrafluoroethylene-perfluoroalkyl vinyl ether copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoroethylene copolymer, an ethylene-acrylic acid copolymer, polyacrylonitrile, and polymethyl methacrylate.

4. The solid electrolyte of claim 1, wherein the solid electrolyte does not comprise a polymer fiber.

5. The solid electrolyte of claim 1, wherein the ionic liquid is at least one compound represented by Formula 1 or Formula 2: 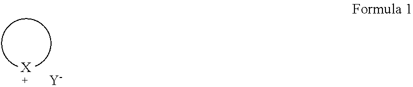
wherein, in Formula 1, 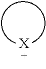
is a 3 to 31-membered ring including at least one heteroatom and 2 to 30 carbon atoms, and is a cycloalkyl ring, an aryl ring, or a heteroaryl ring,
X is —N(R₁)(R₂) or —P(R₁)(R₂),
R₁ and R₂ are each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group, and
Y⁻ is an anion, and 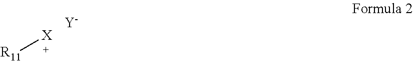
wherein, in Formula 2, X is —N(R₁)(R₂)(R₃) or —P(R₁)(R₂)(R₃),
R₁ to R₃ are each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group,
R₁₁ is an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group, and
Y⁻ is an anion.

6. The solid electrolyte of claim 5, wherein 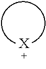
in Formula 1 is one of compounds represented by Formula 3, and 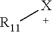
in Formula 2 is a cation represented by Formula 4: 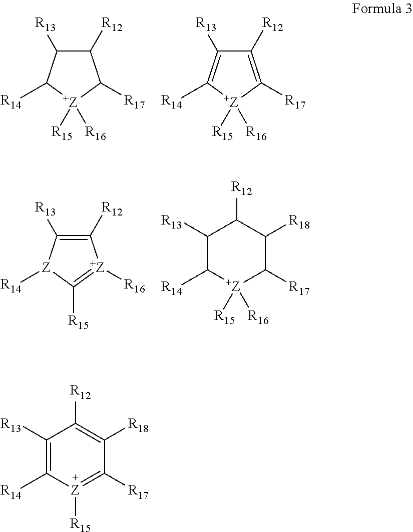
wherein, in Formula 3,
Z is N or P;
R₁₂ to R₁₈ are each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group; 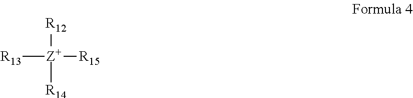
wherein, in Formula 4,
Z is N or P;
R₁₂ to R₁₅ are each independently hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 hetero aryloxy group, an unsubstituted or substituted C4-C30 cycloalkyl group, an unsubstituted or substituted C3-C30 heterocycloalkyl group, or an unsubstituted or substituted C2-C100 alkylene oxide group.

7. The solid electrolyte of claim 1, wherein an amount of the polymer is from about 30 parts by weight to about 300 parts by weight, based on 100 parts by weight of the ionic liquid.

8. The solid electrolyte of claim 1, wherein the lithium salt comprises at least one selected from lithium bis(trifluoromethane)sulfonimide, LiPF₆, LiBF₄, LiAsF₆, LiClO₄, LiNO₃, lithium bis(oxalato) borate, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and lithium trifluoromethanesulfonate.

9. The solid electrolyte of claim 1, wherein an amount of the lithium salt is from about 33 parts by weight to about 300 parts by weight, based on 100 parts by weight of the ionic liquid.

10. The solid electrolyte of claim 1, wherein the inorganic particle comprises at least one selected from SiO₂, TiO₂, Al₂O₃, AlN, SiC, BaTiO₃, graphite oxide, graphene oxide, a metal organic framework, a polyhedral oligomeric silsesquioxane, Li₂CO₃, Li₃PO₄, Li₃N, Li₃S₄, Li₂O, and montmorillonite.

11. The solid electrolyte of claim 1, wherein an amount of the inorganic particle is from about 0.1 part by weight to about 15 parts by weight, based on 100 parts by weight of the ionic liquid.

12. A lithium battery comprising:
a positive electrode;
a negative electrode; and
an electrolyte layer disposed between the positive electrode and the negative electrode, wherein the electrolyte layer comprises a solid electrolyte comprising
an ionic liquid,
a lithium salt,
an inorganic particle, and
a polymer,
wherein an amount of the ionic liquid is greater than or equal to about 33 parts by weight, based on 100 parts by weight of the polymer.

13. The lithium battery of claim 12, wherein the electrolyte layer comprises an electrolyte membrane comprising the solid electrolyte.

14. The lithium battery of claim 12, wherein the lithium battery further comprises an inorganic composite layer disposed between the electrolyte layer and the negative electrode, wherein the inorganic composite layer comprises the inorganic particle.

15. The lithium battery of claim 12, wherein the electrolyte layer comprises a composite electrolyte membrane comprising a separator, and the solid electrolyte is impregnated in the separator.

16. The lithium battery of claim 12, wherein the electrolyte layer has a multilayer structure comprising:
a first electrolyte layer comprising a separator; and
a second electrolyte layer comprising the solid electrolyte.

17. The lithium battery of claim 16, wherein the second electrolyte layer is in contact with the negative electrode or the positive electrode.

18. The lithium battery of claim 16, wherein the first electrolyte layer further comprises at least one electrolyte selected from a liquid electrolyte and a solid electrolyte, wherein the at least one electrolyte is impregnated in the separator.

19. The lithium battery of claim 12, wherein the lithium battery comprises at least one folded portion.

20. The lithium battery of claim 12, wherein the lithium battery comprises a lithium-air battery or a lithium ion battery.
